(19) United States
(12) Patent Application Publication
(10) Pub. No.: US 2020/0403197 A1
(43) Pub. Date: Dec. 24, 2020

(54) BATTERY MODULE WITH STACKED CELLS HAVING OFFSET TABS

(71) Applicant: GM GLOBAL TECHNOLOGY OPERATIONS LLC, Detroit, MI (US)

(72) Inventor: Evan J. Dawley, Bloomfield Hills, MI (US)

(73) Assignee: GM GLOBAL TECHNOLOGY OPERATIONS LLC, Detroit, MI (US)

(21) Appl. No.: 16/444,667

(22) Filed: Jun. 18, 2019

(51) Int. Cl. H01M 2/10

(52) U.S. Cl. CPC H01M 2/1077; H01M 2220/20

(57) ABSTRACT

A battery module includes a housing and multiple battery cells. The housing may have a positive battery module terminal and a negative battery module terminal. The battery cells may be mounted in the housing. Each battery cell may have a positive battery cell terminal and a negative battery cell terminal disposed on opposing battery cell ends. The positive battery cell terminal and the negative battery cell terminal of each battery cell may be offset from a plane perpendicular to the opposing battery cell ends and passing through a center of the battery cell. The battery cells may be arranged as multiple groups with a common side. The positive and negative battery cell terminals on the common side may alternate about the plane in every other group. The groups may be electrically connected in series between the positive battery module terminal and the negative battery module terminal.

### INTRODUCTION

Battery cells within existing battery modules are physically stacked sequentially and an electrical joining path is arranged in series according to the physical stacking. Standard stacking of the battery modules within a battery pack may place battery module terminals in less than ideal locations in relation to a structure of the battery pack and a structure of a vehicle. The existing battery packs and inter-connection board designs suffer where locations of the battery module terminals are in an undesired location for integration purposes. In some designs, the battery module terminals are close to a pack floor and may short circuit when the pack floor is deformed. In other designs, the battery module terminals are close to rocker panels and may short circuit when a neighboring rocker panel is deformed.

### SUMMARY

A battery module is provided herein. The battery module generally includes a housing having a positive battery module terminal and a negative battery module terminal and a plurality of battery cells mounted in the housing. The plurality of battery cells may be configured to store electrical energy. Each of the plurality of battery cells may have a positive battery cell terminal and a negative battery cell terminal disposed on opposing battery cell ends. The positive battery cell terminal and the negative battery cell terminal of each of the plurality of battery cells may be offset from a plane perpendicular to the opposing battery cell ends and passing through a center of the battery cell. The plurality of battery cells may be arranged as a plurality of groups with a common side. The positive battery cell terminals and the negative battery cell terminals on the common side may alternate about the plane in every other one of the plurality of groups. The plurality of groups may be electrically connected in series between the positive battery module terminal and the negative battery module terminal.

In one or more embodiments, the positive battery cell terminal and the negative battery cell terminal of each of the plurality of battery cells may be offset in opposite directions from the plane.

In one or more embodiments, the positive battery cell terminal and the negative battery cell terminal of each of the plurality of battery cells may be offset in a same direction from the plane.

In one or more embodiments, the positive battery module terminal and the negative battery module terminal may be mounted on the housing neighboring a same end battery cell of the plurality of battery cells.

In one or more embodiments, the positive battery module terminal and the negative battery module terminal may be mounted between a first battery cell of the plurality of battery cells and a last battery cell of the plurality of battery cells.

In one or more embodiments, the plurality of groups may be arranged as a plurality of sets, and each of the plurality of sets may have two groups of the plurality of groups oriented with the positive battery cell terminals on the common side.

In one or more embodiments, the positive battery cell terminals and the negative battery cell terminals may physically alternate every other one of the plurality of sets in the housing.

In one or more embodiments, the plurality of battery cells may form part of a high-voltage battery pack.

In one or more embodiments, the high-voltage battery pack may be mountable in a vehicle.

A method for manufacturing a battery module is provided herein. The method may include providing a housing having a positive battery module terminal and a negative battery module terminal. The method may include mounting a plurality of battery cells in the housing. The plurality of battery cells may be configured to store electrical energy. Each of the plurality of battery cells may have a positive battery cell terminal and a negative battery cell terminal disposed on opposing battery cell ends. The positive battery cell terminal and the negative battery cell terminal of each of the plurality of battery cells may be offset from a plane perpendicular to the opposing battery cell ends and passing through a center of the battery cell. The method may include arranging the plurality of battery cells as a plurality of groups with a common side. The positive battery cell terminals and the negative battery cell terminals on the common side may alternate about the plane in every other one of the plurality of groups. The method may include electrically connecting the plurality of groups in series between the positive battery module terminal and the negative battery module terminal.

In one or more embodiments, the positive battery cell terminal and the negative battery cell terminal of each of the plurality of battery cells may be offset in opposite directions from the plane.

In one or more embodiments, the positive battery cell terminal and the negative battery cell terminal of each of the plurality of battery cells may be offset in a same direction from the plane.

In one or more embodiments, the method may include mounting the positive battery module terminal and the negative battery module terminal on the housing neighboring a same end battery cell of the plurality of battery cells.

In one or more embodiments, the method may include mounting the positive battery module terminal and the negative battery module terminal between a first battery cell of the plurality of battery cells and a last battery cell of the plurality of battery cells.

In one or more embodiments, the method may include arranging the plurality of groups as a plurality of sets. Each of the plurality of sets may have two groups of the plurality of groups oriented with the positive battery cell terminals on the common side.

In one or more embodiments, the method may include physically alternating the positive battery cell terminals and the negative battery cell terminals every other one of the sets in the housing.

A battery pack for a vehicle is provided herein. The battery pack may include a positive battery pack terminal, a negative battery pack terminal and a plurality of battery modules electrically connected between the positive battery pack terminal and the negative battery pack terminal. Each of the plurality of battery modules may include a housing having a positive battery module terminal and a negative battery module terminal, and a plurality of battery cells mounted in the housing. The plurality of battery cells may be configured to store electrical energy. Each of the plurality of battery cells may have a positive battery cell terminal and a negative battery cell terminal disposed on opposing battery cell ends. The positive battery cell terminal and the negative battery cell terminal of each of the plurality of battery cells may be offset from a plane perpendicular to the opposing battery cell ends and passing through a center of the battery cell. The plurality of battery cells may be arranged as a plurality of groups with a common side. The positive battery cell terminals and the negative battery cell terminals on the common side may alternate about the plane in every other one of the plurality of groups. The plurality of groups may be electrically connected in series between the positive battery module terminal and the negative battery module terminal.

In one or more embodiments, the battery pack may include a pack floor. The plurality of battery modules may be disposed on the pack floor. The positive battery module terminals and the negative battery module terminals may be disposed on a side of the plurality of battery modules opposite the pack floor.

In one or more embodiments, the vehicle may include a first rocker panel. The positive battery module terminals and the negative battery module terminals may be disposed on a side of the plurality of battery modules opposite the first rocker panel.

In one or more embodiments, the vehicle may include a second rocker panel. Each of the plurality of battery modules may extend from proximate the first rocker panel to proximate the second rocker panel. The positive battery module terminals and the negative battery module terminals may be disposed part way between the first rocker panel and the second rocker panel.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic plan diagram illustrating a context of a system.

FIG. 2 is a schematic exploded perspective diagram of a battery pack in accordance with an exemplary embodiment.

FIG. 3 is a schematic perspective diagram of a battery cell in accordance with an exemplary embodiment.

FIG. 4 is a schematic perspective diagram of another battery cell in accordance with an exemplary embodiment.

FIG. 5 is a schematic perspective diagram of a battery module in accordance with an exemplary embodiment.

FIG. 6 is a schematic diagram of an electrical interconnection of the battery module of FIG. 5 in accordance with an exemplary embodiment.

FIG. 7 is a schematic perspective diagram of another battery module in accordance with an exemplary embodiment.

FIG. 8 is a schematic diagram of an electrical interconnection of the battery module of FIG. 7 in accordance with an exemplary embodiment.

FIG. 9 is a schematic diagram of an electrical interconnection of still another battery module in accordance with an exemplary embodiment.

FIG. 10 is a schematic sideview diagram of a longitudinal-vertically stacked battery module in accordance with an exemplary embodiment.

FIG. 11 is a schematic sideview diagram of a horizontally stacked battery module in accordance with an exemplary embodiment.

FIG. 12 is schematic plan diagram of a battery module in accordance with an exemplary embodiment.

FIG. 13 is a flow diagram of a method for manufacturing a battery module in accordance with an exemplary embodiment.

### DETAILED DESCRIPTION

Embodiments of the design generally provide battery modules and/or a multi-battery-module battery pack for a vehicle. To one degree or another, the various embodiments generally change dependencies of electrical sequences and/or physical sequence of cells and/or groups of battery cells within the battery modules to allow intended placement of battery module terminals. Each battery cell may have two opposing battery cell terminals (or tabs). The battery cell terminals may be physically offset on a diagonal or biased towards an edge of the battery cells.

Each battery module may have numerous groupings (e.g., S groups) of the battery cells arranged in a stack. Each group of battery cells may have some number of battery cells (e.g., P battery cells, where P≥1) electrically wired in parallel. At least two neighboring groups having similar battery cell terminals on a common side of the battery module may form sets of the groups. Two last groupings, or next-to-last groupings, of the cells in the stack may serve as busbars that are electrically coupled through one or more interconnect boards. The interconnect boards may electrically connect the groups of battery cells to the battery module terminals.

Multiple battery modules may be physically arranged to form a battery pack. Placement of the electrical terminals of the battery cells generally allows an intended placement of the battery module terminals to take place. The intended placement of the battery module terminals may allow separation of the battery module terminals from the pack floor and/or rocker panels to take place.

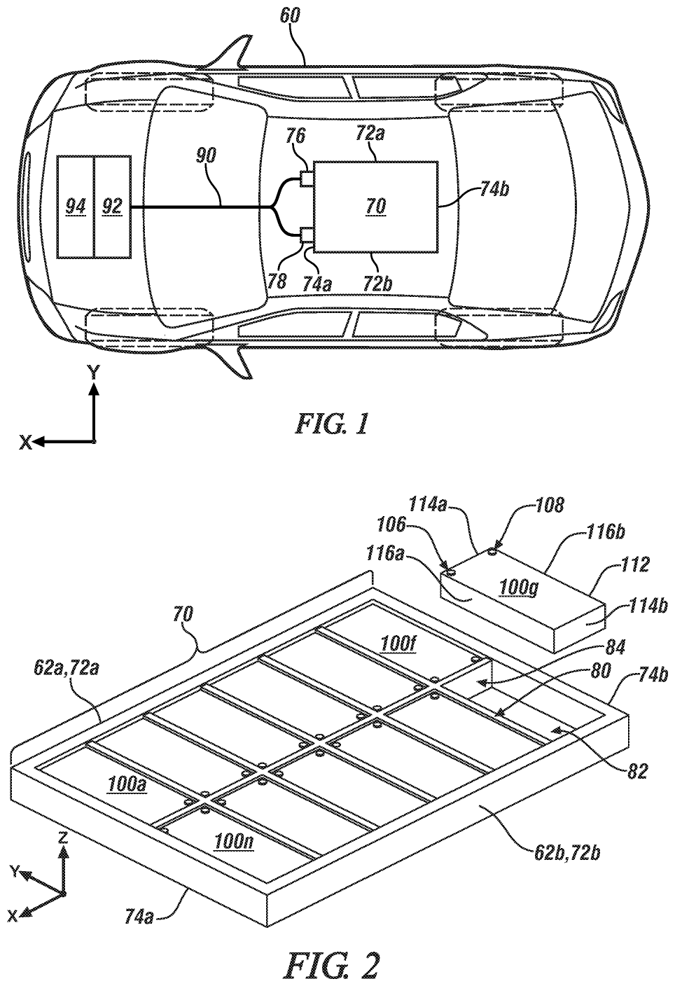

Referring to FIG. 1, a schematic plan diagram illustrating a context of a system is shown. The system may implement a vehicle 60. The vehicle 60 generally comprises a battery pack 70, a harness 90, a controller 92 and a motor 94. The battery pack 70 may include opposing pack sides 72a-72b, opposing pack ends 74a-74b, a positive battery pack terminal 76 and a negative battery pack terminal 78. For the purposes of explanation, a front of the vehicle 60 may be aligned in a positive X direction. A right side of the vehicle 60 (as seen looking down at a top of the vehicle 60) may be aligned in a positive Y direction. The positive Y direction may be perpendicular to the positive X direction.

The vehicle 60 may include, but is not limited to, mobile objects such as automobiles, trucks, motorcycles, boats, trains and/or aircraft. In some embodiments, the vehicle 60 may include stationary objects such as billboards, kiosks and/or marquees. Other types of vehicles 60 may be implemented to meet the design criteria of a particular application.

The battery pack 70 may implement a high-voltage battery pack configured to store electrical energy. The battery pack 70 is generally operational to receive electrical power from the controller 92 and provide electrical power to the controller 92. The battery pack 70 may include multiple battery modules electrically connected in series and/or in parallel between the positive battery pack terminal 76 and the negative battery pack terminal 78. In various embodiments, the battery pack 70 may provide approximately 400 to 800 volts DC (direct current) electrical potential between the positive battery pack terminal 76 and the negative battery pack terminal 78. Other battery voltages may be implemented to meet the design criteria of a particular application. The pack sides 72a-72b may face the positive Y direction and the negative Y direction. The pack ends 74a-74b may face the positive X direction and the negative X direction. The positive battery pack terminal 76 and the negative battery pack terminal 78 may be physically and electrically connected to the harness 90.

The harness 90 may implement an electrical harness. The harness 90 is generally operational to carry electrical power between the controller 92 and the battery pack 70. In a charging mode, the harness 90 may transfer the electrical power from the controller 92 to the battery pack 70. In a discharging mode, the electrical power may flow along the harness 90 from the battery pack 70 to the controller 92.

The controller 92 may implement a battery controller. The controller 92 is generally operational to transfer electrical power to the battery pack 70 in the charging mode to charge the battery pack 70 The controller 92 may draw electrical power from the battery pack 70 in the discharge mode. The electrical power received from the battery pack 70 may be used to power the motor 94 and/or other loads within the vehicle 60.

The motor 94 may implement an electric motor. The motor 94 is generally operational to provide rotation and torque to drive wheels of the vehicle 60. The electrical power consumed by the motor 94 may be provided by the battery pack 70 and/or an alternator of the vehicle 60 under the control of the controller 92.

Referring to FIG. 2, a schematic exploded perspective diagram of an example implementation of the battery pack 70 is shown in accordance with an exemplary embodiment. The battery pack 70 generally comprises the pack sides 72a-72b, the pack ends 74a-74b, the positive battery pack terminal 76 (see FIG. 1), the negative battery pack terminal 78 (see FIG. 1), an optional cross-car beam 80, a pack floor 82, an optional foraft spine 84 and multiple battery modules 100a-100n. Each battery module 100a-100n generally comprises the positive battery module terminal 106, the negative battery module terminal 108 and a housing 112. The housing 112 may include opposing battery module ends 114a-114b and opposing battery module sides 116a-116b. In various embodiments, the battery module terminals 106-108 may be mounted on the housing 112 near one of the battery module ends 114a-114b. In other embodiments, the battery module terminals 106-108 may be mounted on other components with the battery modules 100a-100n (e.g., on interconnect boards) and exposed through opening(s) in the housing 112.

The battery module 100a-100n may be connected in series between the positive battery pack terminal 76 and the negative battery pack terminal 78. A height of the battery pack 70 may be aligned in a positive Z direction. The positive Z direction may be normal to a plane defined by the X direction and the Y direction.

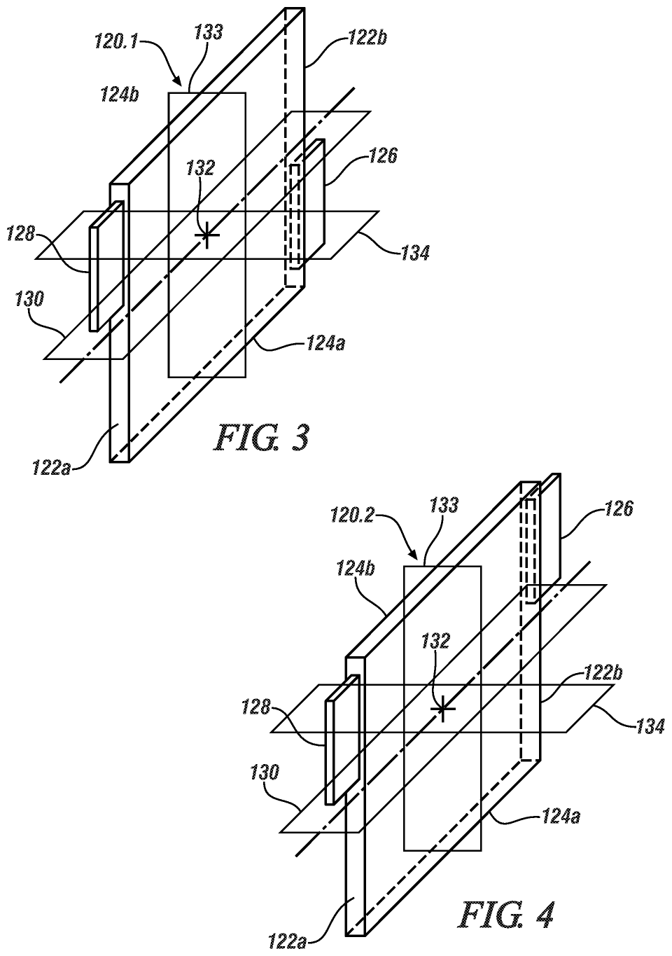

Referring to FIG. 3, a schematic perspective diagram of an example implementation of a battery cell 120.1 is shown in accordance with an exemplary embodiment. The battery cell 120.1 generally comprises opposing battery cell ends 122a-122b, opposing battery cell faces 124a-124b, a positive battery cell terminal 126 and a negative battery cell terminal 128.

The battery cell 120.1 may implement an electrical cell configured to store electrical energy. The battery cell 120.1 is generally operational to receive electrical power while in the charging mode and provide electrical power while in the discharge mode. In some embodiments, the battery cell 120.1 may be configured as a 3.5 volt to 4.2 volt DC cell. Other battery cell voltages may be implemented to meet a design criteria of a particular application.

The battery cell 120.1 may be divided by a plane 130 passing through a center 132 of the battery cell 120.1. The battery cell terminals 126 and 128 may be disposed in opposite directions from the plane 130. The positive battery cell terminal 126 may be disposed on the battery cell end 122b offset to one side of the plane 130. The negative battery cell terminal 128 may be disposed on the battery cell end 122a offset to another side of the plane 130. A diagonal defined between the positive battery cell terminal 126 and the negative battery cell terminal 128 may pass through the center 132 of the battery cell 120.1. A plane 133 may be defined orthogonal to the plane 130 and passing through the center 132 of the battery cell 120.1. The positive battery cell terminal 126 and the negative battery cell terminal 128 may be located on opposite sides of the plane 133. A plane 134 may be defined orthogonal to the planes 130 and 133 and passing through the center 132 of the battery cell 120.1. The positive battery cell terminal 126 and the negative battery cell terminal 128 may be located on opposite sides of the plane 134.

Referring to FIG. 4, a schematic perspective diagram of another example implementation of a battery cell 120.2 is shown in accordance with an exemplary embodiment. The battery cell 120.2 may be a variation of the battery cell 120.1. The battery cell 120.2 generally comprises the opposing battery cell ends 122a-122b, the opposing battery cell faces 124a-124b, the positive battery cell terminal 126 and the negative battery cell terminal 128.

The battery cell 120.2 may implement an electrical cell configured to store electrical energy. The battery cell 120.2 is generally operational to receive electrical power while in the charging mode and provide electrical power while in the discharge mode. In some embodiments, the battery cell 120.2 may be configured as a 3.5 volt to 4.2 volt DC cell. Other battery cell voltages may be implemented to meet a design criteria of a particular application.

The battery cell 120.2 may be divided by the plane 130 passing through the center 132 of the battery cell 120.2 The positive battery cell terminal 126 may be disposed on the battery cell end 122b offset to one side of the plane 130. The negative battery cell terminal 128 may be disposed on the battery cell end 122a offset to the same side of the plane 130. The plane 133 may be defined orthogonal to the plane 130 and passing through the center 132 of the battery cell 120.2. The positive battery cell terminal 126 and the negative battery cell terminal 128 may be located on opposite sides of the plane 133. The plane 134 may be defined orthogonal to the planes 130 and 133 and passing through the center 132 of the battery cell 120.2. The positive battery cell terminal 126 and the negative battery cell terminal 128 may be located on the same side of the plane 134.

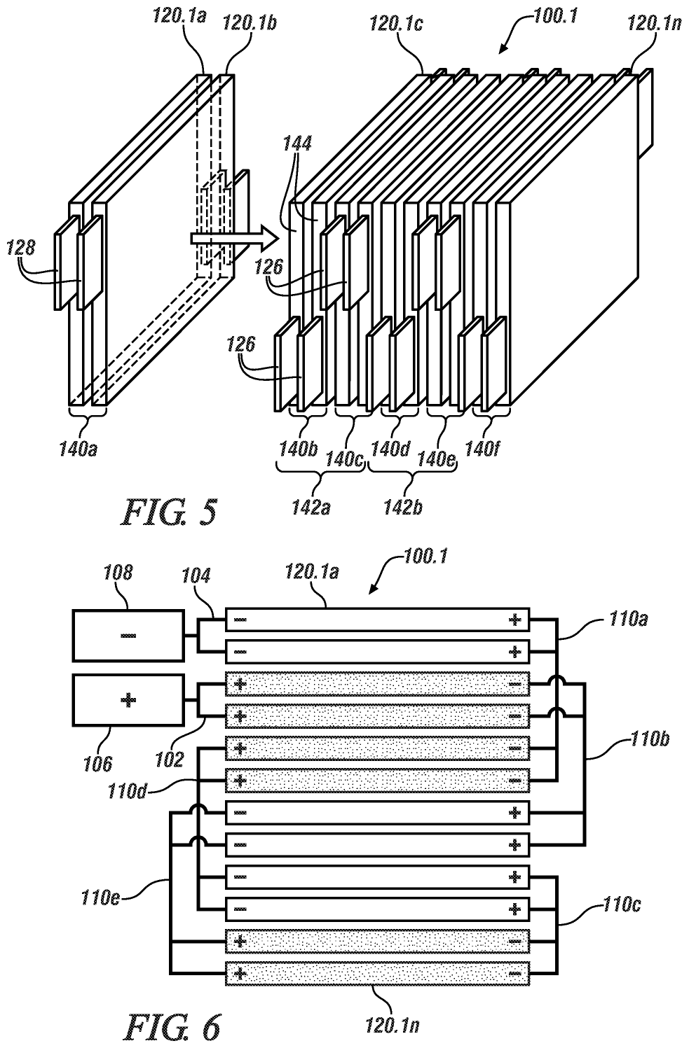

Referring to FIG. 5, a schematic perspective diagram of an example implementation of a battery module 100.1 is shown in accordance with an exemplary embodiment. The battery module 100.1 generally comprises multiple battery cells 120.1a-120.1n, each a copy of the battery cell 120.1 shown in FIG. 3.

The battery cells 120.1a-120.1n may be physically stacked in series with atypical electrical series connections. The battery cells 120.1a-120.1n within the stack may be physically arranged in multiple groups 140a-140f. Each group 140a-140f generally comprises one or more battery cells 120.1a-120.1n.

In configurations having multiple (e.g., two or more) battery cells 120.1a-120.1n within each group 140a-140f, the battery cells 120.1a-120.1n may be physically arranged such that similar battery cell terminals (e.g., the positive battery cell terminals 126) within each group 140a-140f are disposed on a common side 144. For example, both positive battery cell terminals 126 of the battery cells 120.1c and 120.1d may both be on the common side 144. The battery cells 120a.1a-120.1n within each group 140a-140f may be electrically connected in parallel.

The battery cells 120.1a-120.1n in every other group 140a-140f may be physically reversed or reflected in one or more dimensions around the center 132 (e.g., spatially mirrored/rotated about the plane 130 and/or the plane 133 and/or the plane 134 in FIG. 3). As a result, the battery cell terminals 126 and 128 in neighboring groups 140a-140f may offset towards alternating edges (e.g., alternate about the plane 130). For example, the positive battery cell terminals 126 in the battery cells 120.1e and 120.1f may be offset toward an opposite edge as the positive battery cell terminals 126 in the battery cells 120.1c and 120.1d. The groups 140a-140f may be electrically connected in series.

In designs where several (e.g., four or more) groups 140a-140f are implemented, the groups 140b-140e may be arranged in adjoining sets 142a-142b. In various embodiments, the end groups 140a and/or 140f may not be part of a set 142a-142b. In designs where a few (e.g., three or fewer) groups 140a-140f are implemented, the groups 140a-140f may not be arranged as the sets 142a-142b. The sets 142a-142b may be electrically connected in series.

Each set 142a-142b generally comprises multiple (e.g., two or more) groups 140b-140e. The groups 140b-140e within each set 142a-142b may be physically arranged such that similar battery cell terminals (e.g., the positive battery cell terminals 126) within each set 142a-142b are disposed on the common side 144. For example, the four positive battery cell terminals 126 of the battery cells 120.1c-120.1f within the set 142a may be on the common side 144.

Every other set 142a-142b may be physically reversed such that the battery cell terminals 126 and 128 may physically alternate on the common side 144. For example, the positive battery cell terminals 126 in the set 142a and the negative battery cell terminals 128 in the set 142b may be on the common side 144.

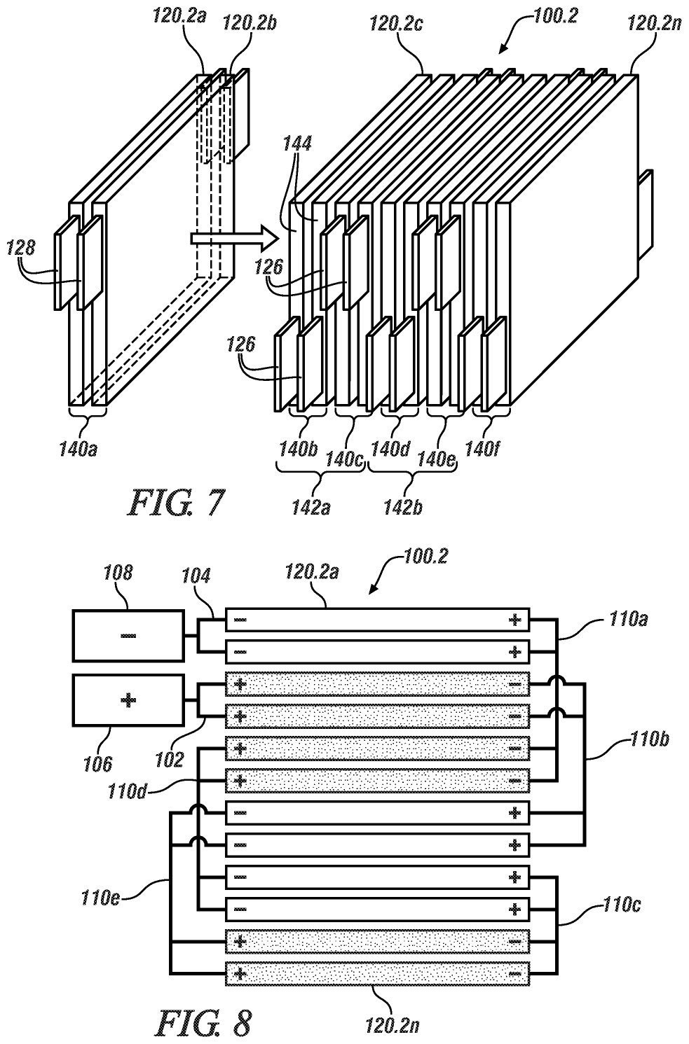

The groups 140a-140f may be physically stacked in series yet electrically connected in a unique series of odd groups (e.g., 140a, 140c and 140e) and even groups (e.g., 140b, 140d and 140f). A voltage of the battery module 100.1 may be a sum of the group voltages (140a+140c+140e)+(140f+140d+140b). The battery module voltage (V_{battery}) may be expressed by a summation of sequences in formula 1 or 2 as follows:

$$\begin{matrix}{V}_{battery} = {\sum }_{i = 1}^{\frac{N}{2}} {V}_{{Group}_{2 i - 1}} + {\sum }_{i = \frac{N}{2}}^{1} {V}_{{Group}_{2 i}} For Even N integers \geq 2 & ( 1 ) \\ {V}_{battery} = {\sum }_{i = 1}^{\frac{N - 1}{2}} {V}_{{Group}_{2 i + 1}} + {\sum }_{i = \frac{N - 1}{2}}^{1} {V}_{{Group}_{2 i}} For Odd N integers \geq 3 & ( 2 )\end{matrix}$$

Where N may be the total number of cell groups 140a-140f used in the battery module 100.1, and N may be an integer greater than 2 (e.g., N=6 as illustrated in FIGS. 5 and 7).

Referring to FIG. 6, a schematic diagram of an example electrical interconnection within the battery module 100.1 is shown in accordance with an exemplary embodiment. The battery module 100.1 may physically locate the positive battery module terminal 106 and the negative battery module terminal 108 near a same end of the stack. The ends of the stack may be desirable locations in relation to a battery pack structure/architecture. The battery module 100.1 may also comprise a positive module connection 102, a negative module connection 104 and multiple internal connections 110a-110e.

The positive module connection 102 may connect the positive battery cell terminals 126 of the next-to last battery cells 120.1a-120.1n in the stack (e.g., the battery cells 120.1c-120.1d) to the positive battery module terminal 106. The negative module connection 104 may connect the negative battery cell terminals 128 of the last battery cells 120.1a-120.1n in the stack (e.g., the battery cells 120.1a-120.1b) to the negative battery module terminal 108. The internal connections 110a-110e may electrically connect the groups in series to establish the battery module voltage between the positive battery module terminal 106 and the negative battery module terminal 108.

Referring to FIG. 7, a schematic perspective diagram of an example implementation of a battery module 100.2 is shown in accordance with an exemplary embodiment. The battery module 100.2 may be a variation of the battery module 100.1. The battery module 100.2 generally comprises multiple battery cells 120.2a-120.2n, each a copy of the battery cell 120.2 shown in FIG. 4.

The battery cells 120.2a-120.2n may be physically stacked in series with atypical electrical series connections. The battery cells 120.2a-120.2n within the stack may be physically arranged in the multiple groups 140a-140f. Each group 140a-140f generally comprises one or more battery cells 120.2a-120.2n.

In configurations having multiple (e.g., two or more) battery cells 120.2a-120.2n within each group 140a-140f may be physically arranged such that similar battery cell terminals (e.g., the positive battery cell terminals 126) within each group 140a-140f are disposed on the common side 144. For example, both positive battery cell terminals 126 of the battery cells 120.2c and 120.2d may both be on the common side 144. The battery cells 120.2a-120.2n within each group 140a-140f may electrically connected in parallel.

The battery cells 120.2a-120.2n in every other group 140a-140f may be physically reversed or reflected in one or more dimensions around the center 132 (e.g., spatially mirrored/rotated about the plane 130 and/or plane 133 and or plane 134 in FIG. 4). As a result, the battery cell terminals 126 and 128 in neighboring groups 140a-140f may offset towards alternating edges (e.g., alternate about the plane 130). For example, the positive battery cell terminals 126 in the cells 120.2e and 120.2f may be offset toward an opposite edge as the positive battery cell terminals 126 in the battery cells 120.2c and 120.2d. The groups 140a-140f may be electrically connected in series.

In designs where several (e.g., four or more) groups 140a-140f are implemented, the groups 140b-140e may be arranged in the adjoining sets 142a-142b. In various embodiments, the end groups 140a and/or 140f may not be part of a set 142a-142b. In designs where a few (e.g., three or fewer) groups 140a-140f are implemented, the groups 140a-140f may not be arranged as the sets 142a-142b. The sets 142a-142b may be electrically connected in series.

Each set 142a-142b generally comprises multiple (e.g., two or more) groups 140b-140e. The groups 140b-140e within each set 142a-142b may be physically arranged such that similar battery cell terminals (e.g., the positive battery cell terminals 126) within each set 142a-142b are disposed on the common side 144. For example, the four positive battery cell terminals 126 of the battery cells 120.2c-120.2f within the set 142a may be on the common side 144.

Every other set 142a-142b may be physically reversed such that the battery cell terminals 126 and 128 may physically alternate on the common side 144. For example, the positive battery cell terminals 126 in the set 142a and the negative battery cell terminals 128 in the set 142b may be on the common side 144.

The groups 140a-140f may be physically stacked in series yet electrically connected in a unique series of odd groups (e.g., 140a, 140c and 140e) and even groups (e.g., 140b, 140d and 140f). A voltage of the battery module 100.2 may be a sum of the group voltages (140a+140c+140e)+(140f+140d+140b). The battery module voltage V_{battery} may be expressed by summation of sequences in formula 1 or 2, depending on odd or even N groups.

Referring to FIG. 8, a schematic diagram of an example electrical interconnection within the battery module 100.2 is shown in accordance with an exemplary embodiment. The battery module 100.2 may physically locate the positive battery module terminal 106 and the negative battery module terminal 108 near a same end of the stack. The ends of the stack may be desirable locations in relation to the battery pack structure/architecture. The battery module 100.2 may also comprise the positive module connection 102, the negative module connection 104 and the multiple internal connections 110a-110e.

The positive module connection 102 may connect the positive battery cell terminals 126 of the next-to last battery cells 120.2a-120.2n in the stack (e.g., the battery cells 120.2c-120.2d) to the positive battery module terminal 106. The negative module connection 104 may connect the negative battery cell terminals 128 of the last battery cells 120.2a-120.2n in the stack (e.g., the battery cells 120.2a-120.2b) to the negative battery module terminal 108. The internal connections 110a-110e may electrically connect the groups in series to establish the battery module voltage between the positive battery module terminal 106 and the negative battery module terminal 108.

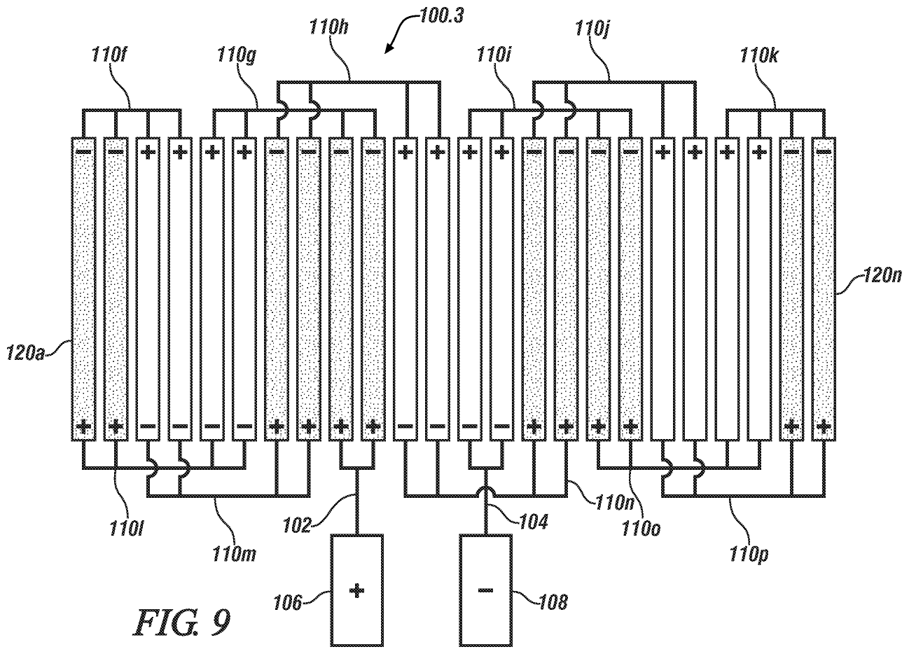

Referring to FIG. 9, a schematic diagram of an example electrical interconnection within a battery module 100.3 is shown in accordance with an exemplary embodiment. The battery module 100.3 may be a variation of the battery module 100.1 and/or the battery module 100.2. The battery module 100.3 generally comprises the positive module connection 102, the negative module connection 104, the positive battery module terminal 106, the negative battery module terminal 108, multiple internal connections 110a-110p and multiple battery cells 120a-120n. The battery cells 120a-120n may be physically stacked in series with atypical electrical series connections. The battery module 100.3 may physically locate the positive battery module terminal 106 and the negative battery module terminal 108 at any location between the first battery cell 120a of the stack and a last battery cell 120n of the stack (e.g., near a center of the stack as illustrated). The center of the stack may be a desirable location in relation to the battery pack structure/architecture. The battery cells 120a-120n may be multiple battery cells 120.1, multiple battery cells 120.2 or a mixture of the battery cells 120.1 and 120.2.

The positive module connection 102 may connect the positive battery cell terminals 126 of more centrally located battery cells 120a-120n in the stack to the positive battery module terminal 106. The negative module connection 104 may connect the negative battery cell terminals 128 of neighboring central battery cells 120a-120n in the stack to the negative battery module terminal 108. The internal connections 110a-110p may electrically connect the groups in series to establish the battery module voltage between the positive battery module terminal 106 and the negative battery module terminal 108.

The groups of battery cells 120a-120n may be physically stacked in series yet electrically connected in a unique series of odd groups and even groups. A voltage of the battery module 100.3 may be a sum of the group voltages. The battery module voltage V_{battery} may be expressed by one of the following formulas 3-6. Formulas 3-4 may apply for even number of N groups while formulas 5-6 may apply for odd number of N groups. Formula 3 places the module terminals on an even-numbered cell group, while formula 4 places the module terminals on an odd-numbered cell group in modules with an even number of N groups. Likewise, formula 5 places the module terminals on an odd-numbered cell group, while formula 6 places the module terminals on an even-numbered cell group in modules with an odd number of N groups. The uniqueness of module 100.3 in FIG. 9 generally resides in the ability to select some intermediate cell group N and the neighboring cell group between the first group and last group to bear the module terminals.

$$\begin{matrix}{V}_{battery} = {\sum }_{i = \tilde{N}}^{\frac{N}{2}} {V}_{{Group}_{2 i - 1}} + {\sum }_{i = \frac{N}{2}}^{1} {V}_{{Group}_{2 i}} + {\sum }_{i = 1}^{\tilde{N} - 1} {V}_{{Group}_{2 i - 1}} \begin{matrix}\begin{matrix} \\ For Even N integers \geq 6\end{matrix} \\ and 1 < \tilde{N} < \frac{N}{2} \end{matrix} & ( 3 ) \\ {V}_{battery} = {\sum }_{i = \tilde{N}}^{\frac{N}{2}} {V}_{{Group}_{2 i}} + {\sum }_{i = \frac{N}{2}}^{1} {V}_{{Group}_{2 i - 1}} + {\sum }_{i = 1}^{\tilde{N} - 1} {V}_{{Group}_{2 i}} \begin{matrix}\begin{matrix} \\ For Even N integers \geq 6\end{matrix} \\ and 1 < \tilde{N} < \frac{N}{2} \end{matrix} & ( 4 ) \\ {V}_{battery} = {\sum }_{i = \tilde{N}}^{\frac{N - 1}{2}} {V}_{{Group}_{2 i + 1}} + {\sum }_{i = \frac{N - 1}{2}}^{1} {V}_{{Group}_{2 i}} + {\sum }_{i = 1}^{\tilde{N}} {V}_{{Group}_{2 i - 1}} \begin{matrix}\begin{matrix} \\ For Odd N integers \geq 5\end{matrix} \\ and 1 < \tilde{N} < \frac{N - 1}{2} \end{matrix} & ( 5 ) \\ {V}_{battery} = {\sum }_{i = \tilde{N}}^{\frac{N - 1}{2}} {V}_{{Group}_{2 i}} + {\sum }_{i = \frac{N - 1}{2}}^{1} {V}_{{Group}_{2 i + 1}} + {\sum }_{i = 1}^{\tilde{N}} {V}_{{Group}_{2 i}} \begin{matrix}\begin{matrix} \\ For Odd N integers \geq 5\end{matrix} \\ and 1 < \tilde{N} < \frac{N - 1}{2} \end{matrix} & ( 6 )\end{matrix}$$

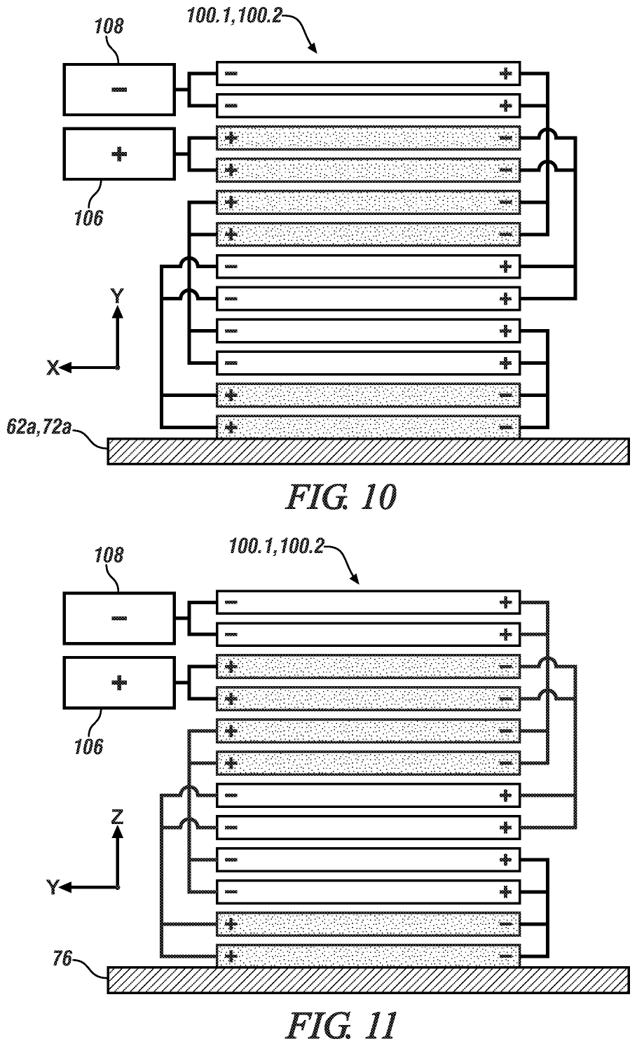

Referring to FIG. 10, a schematic sideview diagram of a longitudinal-vertically stacked battery module 100.1 or 100.2 is shown in accordance with an exemplary embodiment. In the vertical-longitudinal orientation, the positive battery module terminal 106 and the negative battery module terminal 108 may be positioned interior to the vehicle 60 and removed from close proximity to the rocker panels 62a-62b (e.g., rocker panel 62a illustrated) and/or the pack sides 72a-72b (e.g., pack side 72a illustrated). Battery module 100.1 or 100.2 mounted on the other side of the foraft spine 84 may also be oriented with the battery module terminals 106-108 positioned toward the interior of the vehicle 60. Therefore, deformation of the rocker panels 62a-62b and/or the pack sides 72a-72b has a reduced probability of causing damage and/or short circuiting of the battery module terminals 106-108 to each other, the rocker panels 62a-62b, the walls of the battery pack 70, a cover over the battery pack 70 and/or the pack floor 82.

Referring to FIG. 11, a schematic sideview diagram of a horizontally stacked battery module 100.1 or 100.2 is shown in accordance with an exemplary embodiment. In the horizontal orientations the battery module terminals 106-108 may be more readily access from the top of the battery pack 70. The horizontal orientation may also reduce complications to the busbar routing in inter-connect boards. The battery module terminals 106-108 may also be removed from close proximity to the pack floor 82. Therefore, deformation of the pack floor 82 has a reduced probability of causing damage and/or short circuiting of the battery module terminals 106-108 to each other, the walls of the battery pack 70 and/or the pack floor 82.

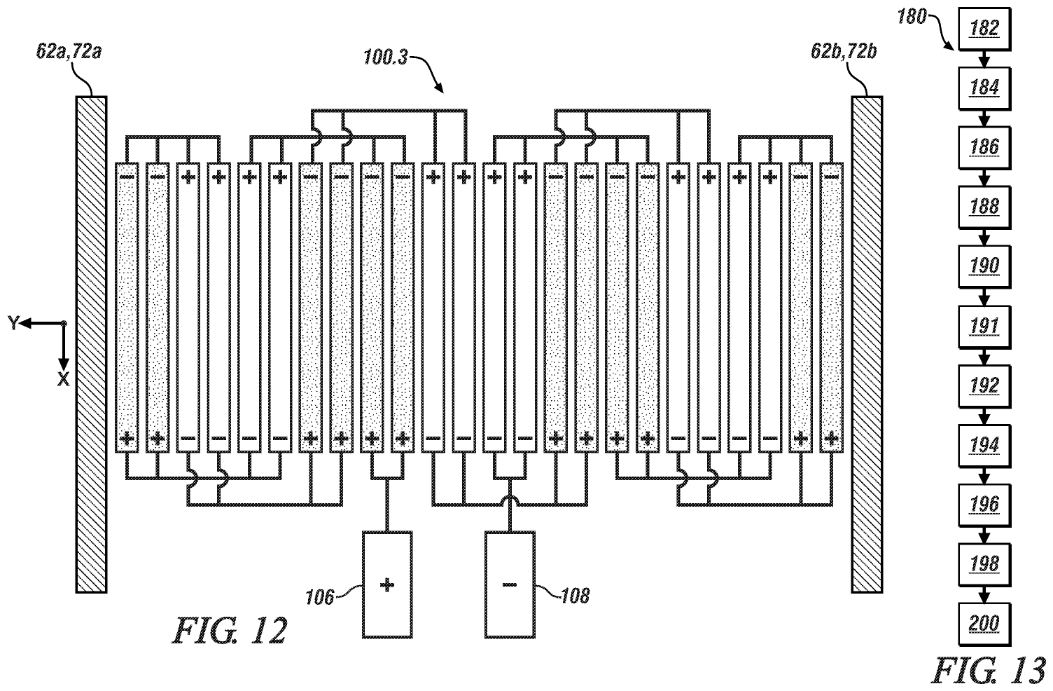

Referring to FIG. 12, a schematic plan diagram of the battery module 100.3 is shown in accordance with an exemplary embodiment. Using a lateral-vertical orientation for the battery cells 120a-120n, the battery module terminals 106-108 may be positioned interior to the vehicle 60 along a centerline of the battery pack 70. Therefore, deformation of the rocker panels 62a-62b and/or the pack sides 72a-72b has a reduced probability of causing damage and/or short circuiting of the battery module terminals 106-108 to each other, the rocker panels 62a-62b and/or the pack sides 72a-72b.

Referring to FIG. 13, a flow diagram of a method for manufacturing a battery module in accordance with an exemplary embodiment. The method (or process) 180 may be implemented with common fabrication techniques. The method 180 generally comprises a step (or state) 182, a step (or state) 184, a step (or state) 186 a step (or state) 188, a step (or state) 190, a step (or state) 191, a step (or state) 192, a step (or state) 194, a step (or state) 196, a step (or state) 198 and a step (or state) 200. The sequence of steps 182 to 200 is shown as a representative example. Other step orders may be implemented to meet the criteria of a particular application. Additional components and/or steps not mentioned may also be implemented to meet the criteria of a particular application.

In step 182, the housing and the battery cells of the battery module may be provided. The battery cells may be arranged into groups in step 184. The battery cell terminals within each group may be disposed on the same side of the group. The groups may be arranged into sets in step 186. In step 188, the groups may be arranged in a physically alternating sequence so that the positive battery cell terminals (or the negative battery cell terminals) are on the same side within the set.

In step 190, the battery cells may subsequently be mounted in the housing. An interconnect board may be installed in the housing in step 191. The interconnect board is generally used to electrically couple the battery cell terminals and making provisions for welding operations in subsequent steps. In various embodiments, the interconnect board may bear the positive internal connections and the negative internal connections of the battery stack. In some embodiments, the battery cell terminals within each group may be electrical connected in parallel in step 192. In step 194, the group terminals may be electrically connected in series between the positive battery module terminal and the negative battery module terminal. In other embodiments, step 192 and step 194 may be performed together as a single step. For example, the positive battery cell terminals of one group may be joined to the negative battery cell terminals of the next series group in a welding operation. In another example, the positive battery cell terminals of one group may be joined to an intermediate busbar and the negative battery cell terminals of the next series group may be connected to the same busbar. The battery module terminals may be mounted to the housing in step 196. A cover is generally attached in step 198. In step 200, testing of the assembled battery module may be performed.

Battery cells with offset tabs on a diagonal or with tabs biased to one edge of the battery cell may be suitable for the disclosed architecture. The physical separation of the tabs away from the cell centerline generally permits inter-cell connections between non-neighboring groups of battery cells. In various embodiments, the cell groups may be stacked in a common physical series but in an atypical electrical series. The physical sequence and the electrical sequence of the cell groups may not directly coincide or be in some series other than a natural series. Furthermore, the battery cell terminals may be disposed or biased toward one side of the battery cell to meet the design criteria of particular application. Battery packs and battery modules made from the battery cells may have battery module terminals located in desired position interior to a vehicle perimeter.

Various embodiments may tailor placement of the battery module terminals in desirable location for packaging benefits. The tailor placement may provide better manufacturability and design flexibility of the components relative to standard designs. In combination with protected/finger-proof battery module terminals, the large format sections may increase pack energy density and reduce a number of parts.

While the best modes for carrying out the disclosure have been described in detail, those familiar with the art to which this disclosure relates will recognize various alternative designs and embodiments for practicing the disclosure within the scope of the appended claims.

What is claimed is:

1. A battery module comprising:
a housing having a positive battery module terminal and a negative battery module terminal; and
a plurality of battery cells mounted in the housing, wherein:
the plurality of battery cells are configured to store electrical energy;
each of the plurality of battery cells has a positive battery cell terminal and a negative battery cell terminal disposed on opposing battery cell ends;
the positive battery cell terminal and the negative battery cell terminal of each of the plurality of battery cells are offset from a plane perpendicular to the opposing battery cell ends and passing through a center of the battery cell;
the plurality of battery cells are arranged as a plurality of groups with a common side;
the positive battery cell terminals and the negative battery cell terminals on the common side alternate about the plane in every other one of the plurality of groups; and
the plurality of groups are electrically connected in series between the positive battery module terminal and the negative battery module terminal.

2. The battery module of claim 1, wherein the positive battery cell terminal and the negative battery cell terminal of each of the plurality of battery cells are offset in opposite directions from the plane.

3. The battery module of claim 1, wherein the positive battery cell terminal and the negative battery cell terminal of each of the plurality of battery cells are offset in a same direction from the plane.

4. The battery module of claim 1, wherein the positive battery module terminal and the negative battery module terminal are mounted on the housing neighboring a same end battery cell of the plurality of battery cells.

5. The battery module of claim 1, wherein the positive battery module terminal and the negative battery module terminal are mounted between a first battery cell of the plurality of battery cells and a last battery cell of the plurality of battery cells.

6. The battery module of claim 1, wherein the plurality of groups are arranged as a plurality of sets, and each of the plurality of sets has one or more groups of the plurality of groups oriented with the positive battery cell terminals on the common side.

7. The battery module of claim 6, wherein the positive battery cell terminals and the negative battery cell terminals physically alternate every other one of the sets in the housing.

8. The battery module of claim 1, wherein the plurality of battery cells form part of a high-voltage battery pack.

9. The battery module of claim 8, wherein the high-voltage battery pack is mountable in a vehicle.

10. A method for manufacturing a battery module, the method comprising:
providing a housing having a positive battery module terminal and a negative battery module terminal;
mounting a plurality of battery cells in the housing, wherein:
the plurality of battery cells are configured to store electrical energy;
each of the plurality of battery cells has a positive battery cell terminal and a negative battery cell terminal disposed on opposing battery cell ends; and
the positive battery cell terminal and the negative battery cell terminal of each of the plurality of battery cells are offset from a plane perpendicular to the opposing battery cell ends and passing through a center of the battery cell;
arranging the plurality of battery cells as a plurality of groups with a common side, wherein the positive battery cell terminals and the negative battery cell terminals on the common side alternate about the plane in every other one of the plurality of groups; and
electrically connecting the plurality of groups in series between the positive battery module terminal and the negative battery module terminal.

11. The method of claim 10, wherein the positive battery cell terminal and the negative battery cell terminal of each of the plurality of battery cells are offset in opposite directions from the plane.

12. The method of claim 10, wherein the positive battery cell terminal and the negative battery cell terminal of each of the plurality of battery cells are offset in a same direction from the plane.

13. The method of claim 10, further comprising:
mounting the positive battery module terminal and the negative battery module terminal on the housing neighboring a same end battery cell of the plurality of battery cells.

14. The method of claim 10, further comprising:
mounting the positive battery module terminal and the negative battery module terminal between a first battery cell of the plurality of battery cells and a last battery cell of the plurality of battery cells.

15. The method of claim 10, further comprising:
arranging the plurality of groups as a plurality of sets, wherein each of the plurality of sets has one or more groups of the plurality of groups oriented with the positive battery cell terminals on the common side.

16. The method of claim 15, further comprising:
physically alternating the positive battery cell terminals and the negative battery cell terminals every other one of the sets in the housing.

17. A battery pack for a vehicle, the battery pack comprising:
a positive battery pack terminal;
a negative battery pack terminal; and
a plurality of battery modules electrically connected between the positive battery pack terminal and the negative battery pack terminal, wherein each of the plurality of battery modules includes:
a housing having a positive battery module terminal and a negative battery module terminal, and
a plurality of battery cells mounted in the housing, wherein:
the plurality of battery cells are configured to store electrical energy;
each of the plurality of battery cells has a positive battery cell terminal and a negative battery cell terminal disposed on opposing battery cell ends;
the positive battery cell terminal and the negative battery cell terminal of each of the plurality of battery cells are offset from a plane perpendicular to the opposing battery cell ends and passing through a center of the battery cell;
the plurality of battery cells are arranged as a plurality of groups with a common side;
the positive battery cell terminals and the negative battery cell terminals on the common side alternate about the plane in every other one of the plurality of groups; and
the plurality of groups are electrically connected in series between the positive battery module terminal and the negative battery module terminal.

18. The battery pack of claim 17, further comprising a pack floor, wherein the plurality of battery modules are disposed on the pack floor, and the positive battery module terminals and the negative battery module terminals are disposed on a side of the plurality of battery modules opposite the pack floor.

19. The battery pack of claim 17, wherein the vehicle comprises a first rocker panel, and the positive battery module terminals and the negative battery module terminals are disposed on a side of the plurality of battery modules opposite the first rocker panel.

20. The battery pack of claim 19, wherein the vehicle comprises a second rocker panel, each of the plurality of battery modules extends from proximate the first rocker panel to proximate the second rocker panel, and the positive battery module terminals and the negative battery module terminals are disposed part way between the first rocker panel and the second rocker panel.
